(19) United States
(12) Patent Application Publication
(10) Pub. No.: US 2024/0108976 A1
(43) Pub. Date: Apr. 4, 2024

(54) PHONE BRACKET

(71) Applicant: SANE Products Inc., Pasadena, CA (US)

(72) Inventors: Pei-Hsun LU, New Taipei City (TW); Christopher Michael MANCINI, Summerland, CA (US)

(21) Appl. No.: 18/376,634

(22) Filed: Oct. 4, 2023

Related U.S. Application Data
(60) Provisional application No. 63/412,920, filed on Oct. 4, 2022.

(51) Int. Cl. A63F 13/24; A45C 11/00; A63F 13/92

(52) U.S. Cl. CPC A63F 13/24; A45C 11/00; A63F 13/92; A45C 2011/002

(57) ABSTRACT

A phone bracket configured to support two controllers and a smartphone. The phone bracket includes two controller supporting bodies and a mounting body. The two controller supporting bodies are configured to support the two controllers, respectively. The mounting body has two first side surfaces and two second side surfaces. The two first side surfaces face away from each other. The two second side surfaces face away from each other and are located between the two first side surfaces. A distance between the two first side surfaces is shorter than a distance between the two second side surfaces. The two controller supporting bodies are respectively and selectively disposed on the two first side surfaces or the two second side surfaces of the mounting body so as to adjust a distance between the two controller supporting bodies and to allow the phone bracket to selectively support the smartphone.

### CROSS-REFERENCE TO RELATED APPLICATIONS

This non-provisional application claims priority under 35 U.S.C. § 119(a) on provisional patent application No(s). 63/412,920 filed in U.S.A. on Oct. 4, 2022, the entire contents of which are hereby incorporated by reference.

### TECHNICAL FIELD

The disclosure relates to a phone accessory, more particularly to a phone bracket.

### BACKGROUND

Recently, smartphone has become an indispensable electronic product in daily life, and thus the mobile games played on the smartphone become more and more popular. In order to enhance the user experience in mobile games, a bracket supporting the smartphone as well as a controller is developed so as to allow users to execute more delicate operations or micromanage in mobile games through the controller.

However, when playing mobile games, it is common to place the smartphone horizontally. Thus, the bracket supporting the smartphone and the controller is required to have large horizontal size. In this way, there could be an inconvenience in storing the bracket.

### SUMMARY

The disclosure provides a phone bracket that can be conveniently stored.

One embodiment of this disclosure provides a phone bracket configured to support two controllers and a smartphone. The phone bracket includes two controller supporting bodies and a mounting body. The two controller supporting bodies are configured to support the two controllers, respectively. The mounting body has two first side surfaces and two second side surfaces. The two first side surfaces face away from each other. The two second side surfaces face away from each other. The two second side surfaces are located between the two first side surfaces. A distance between the two first side surfaces is shorter than a distance between the two second side surfaces. The two controller supporting bodies are respectively and selectively disposed on the two first side surfaces or the two second side surfaces of the mounting body so as to adjust a distance between the two controller supporting bodies and to allow the phone bracket to selectively support the smartphone.

According to the phone bracket disclosed by above embodiments, the distance between the two first side surfaces is shorter than the distance between the two second side surfaces, and the two controller supporting bodies are respectively and selectively disposed on the two first side surfaces or the two second side surfaces of the mounting body so as to adjust the distance between the two controller supporting bodies. Thus, when the two controller supporting bodies are disposed on the two first side surfaces of the mounting body, the phone bracket has a smaller horizontal size, making it easier to be stored. Also, when the two controller supporting bodies are disposed on the two second side surfaces of the mounting body, the phone bracket has a larger horizontal size to support the smartphone.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view showing that two controllers are supported on a phone bracket according to one embodiment of the disclosure that is in a stored state;

FIG. 2 is an exploded view of the controllers and the phone bracket in FIG. 1;

FIG. 3 is an exploded view of the controllers and the phone bracket in FIG. 1 along another viewing angle;

FIG. 4 is a perspective view of the phone bracket in FIG. 1 that is in an expanded state;

FIG. 5 is a perspective view showing that the two controllers and a smartphone are supported on the phone bracket in FIG. 1 that is in the expanded state;

FIG. 6 is an exploded view of the controllers, the smartphone and the phone bracket in FIG. 5; and

FIG. 7 is an exploded view of the controllers, the smartphone and the phone bracket in FIG. 5 along another viewing angle.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

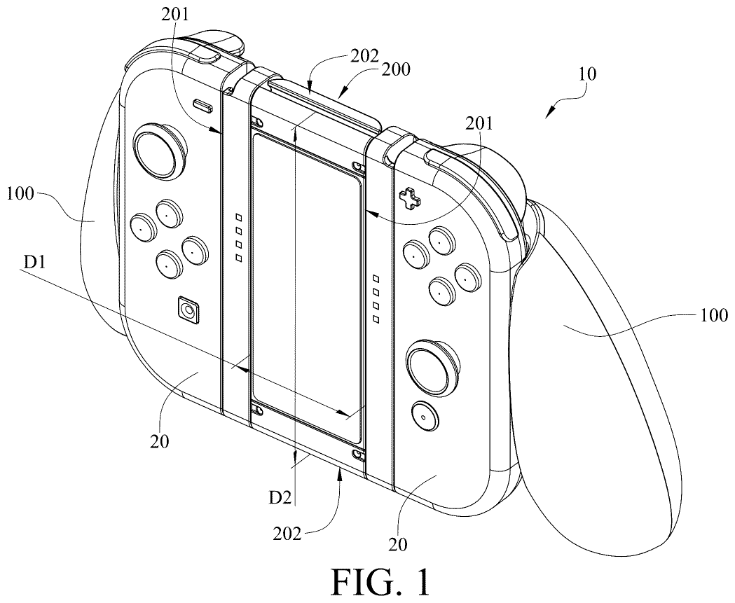

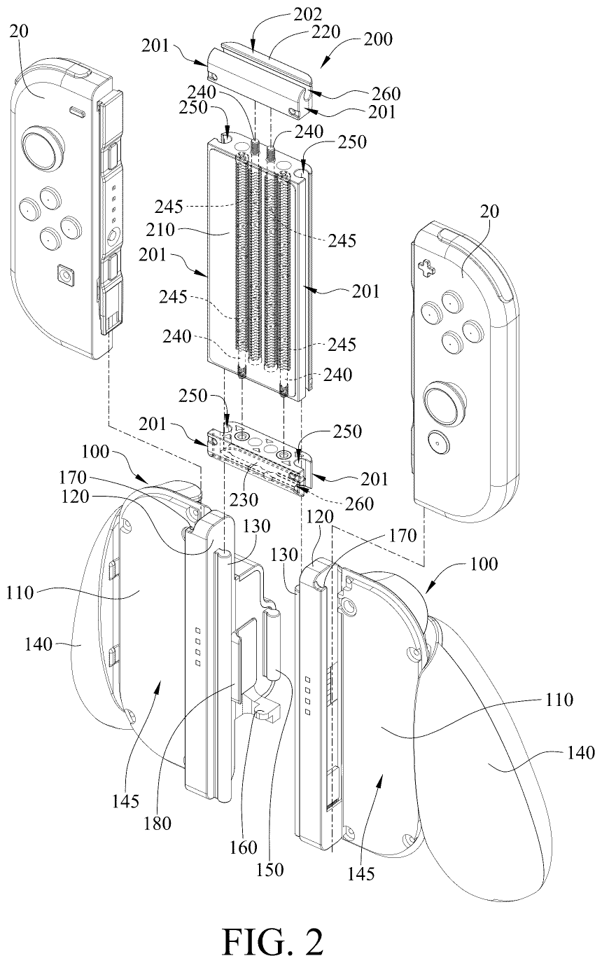

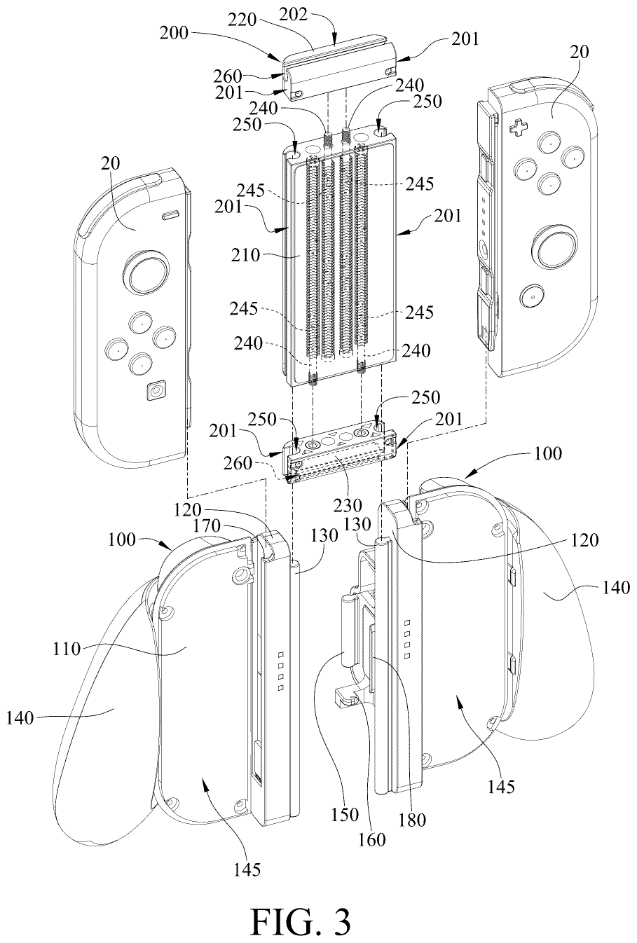

Please refer to FIGS. 1 to 3. FIG. 1 is a perspective view showing that two controllers 20 are supported on a phone bracket 10 according to one embodiment of the disclosure that is in a stored state. FIG. 2 is an exploded view of the controllers 20 and the phone bracket 10 in FIG. 1. FIG. 3 is an exploded view of the controllers 20 and the phone bracket 10 in FIG. 1 along another viewing angle.

In this embodiment, the phone bracket 10 includes two controller supporting bodies 100 and a mounting body 200. Since the two controller supporting bodies 100 are similar in structure, only the detail structure of one controller supporting body 100 will be described hereinafter. In this embodiment, the controller supporting body 100 has a first assembling structure 130 and a second assembling structure 150, and includes a supporting part 110, a mounting part 120, a handheld part 140, a supporting protrusion 160, an engagement protrusion 170 and a blocking protrusion 180.

The mounting part 120 and the handheld part 140 are located on two opposite sides of the supporting part 110, respectively. The supporting part 110, the mounting part 120 and the handheld part 140 together form an accommodation space 145 for accommodating the controller 20 therein. The controller 20 is, for example, a switch controller.

In this embodiment, the first assembling structure 130 and the second assembling structure 150 are, for example, sliders. Additionally, the first assembling structure 130 and the second assembling structure 150 are located on a side of the mounting part 120 that is located farthest away from the supporting part 110. The first assembling structure 130 is located closer to the accommodation space 145 than the second assembling structure 150.

The supporting protrusion 160 protrudes from a side of the mounting part 120 that is located farthest away from the supporting part 110, and is located between the first assembling structure 130 and the second assembling structure 150. The engagement protrusion 170 protrudes toward the accommodation space 145 from the mounting part 120, and is configured to be engaged with the controller 20. The blocking protrusion 180 protrudes from the side of the mounting part 120 that is located farthest away from the supporting part 110, and is located between the first assembling structure 130 and the second assembling structure 150.

In this embodiment, the mounting body 200 includes a base 210, two mounting bases 220 and 230, a plurality of mounting rods 240, a plurality of elastic components 245, two third assembling structures 250 and two fourth assembling structures 260, and has two first side surfaces 201 and two second side surfaces 202. In this embodiment, the mounting rods 240 are disposed through the base 210. The elastic components 245 are, for example, springs. The two mounting bases 220 and 230 are movably disposed on the base 210 via the mounting rods 240 and the elastic components 245.

The two first side surfaces 201 face away from each other. The two second side surfaces 202 face away from each other. The two second side surfaces 202 are located between the two first side surfaces 201. A distance D1 between the two first side surfaces 201 is shorter than a distance D2 between the two second side surfaces 202. The base 210 and the two mounting bases 220 and 230 together form the two first side surfaces 201. The two second side surfaces 202 are located on the two mounting bases 220 and 230, respectively. The two second side surfaces 202 face away from the base 210. The two third assembling structures 250 and the two fourth assembling structures 260 are, for example, sliding grooves. The two third assembling structures 250 are located on the two first side surfaces 201, respectively. The two fourth assembling structures 260 are located on the two second side surfaces 202, respectively. In addition, in this embodiment, the two third assembling structures 250 are located on the base 210 and the mounting base 230, and is spaced apart from the other mounting base 220. Thus, when the mounting body 200 is mounted on the controller supporting bodies 100 via the first assembling structures 130 and the third assembling structures 250, the mounting base 220 restricts the movement between the mounting body 200 and the controller supporting bodies 100. Specifically, the mounting base 220 blocks the mounting body 200 when the mounting body 200 slides to the position as shown in FIG. 1. Note that in other embodiments, the third assembling structures may be located on the base and the two mounting bases.

The stored state of the phone bracket 10 will be firstly described. As shown in FIGS. 1-3, when the phone bracket 10 is in the stored state, the two first assembling structures 130 of the two controller supporting bodies 100 are slidably assembled to the two third assembling structures 250, respectively. The two accommodation spaces 145 of the two controller supporting bodies 100 are configured to support the two controllers 20, respectively.

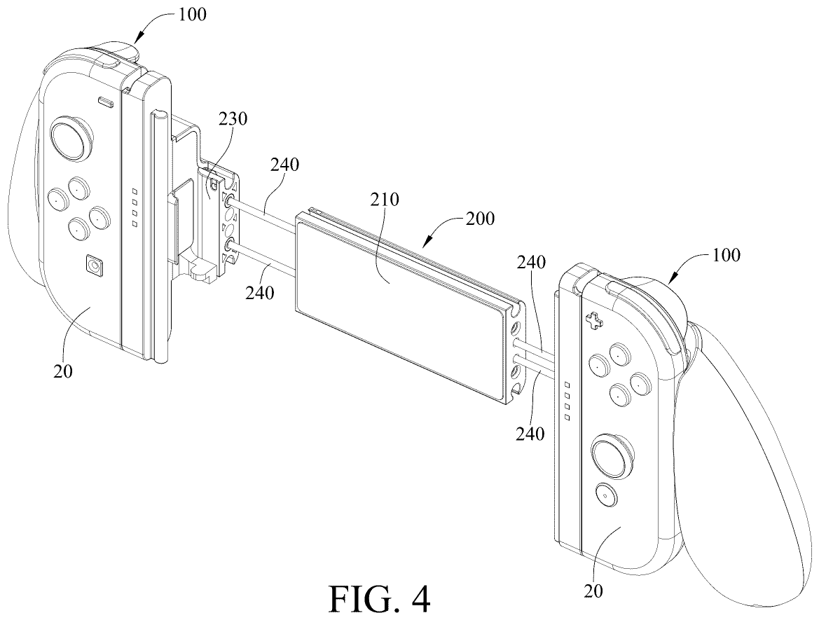

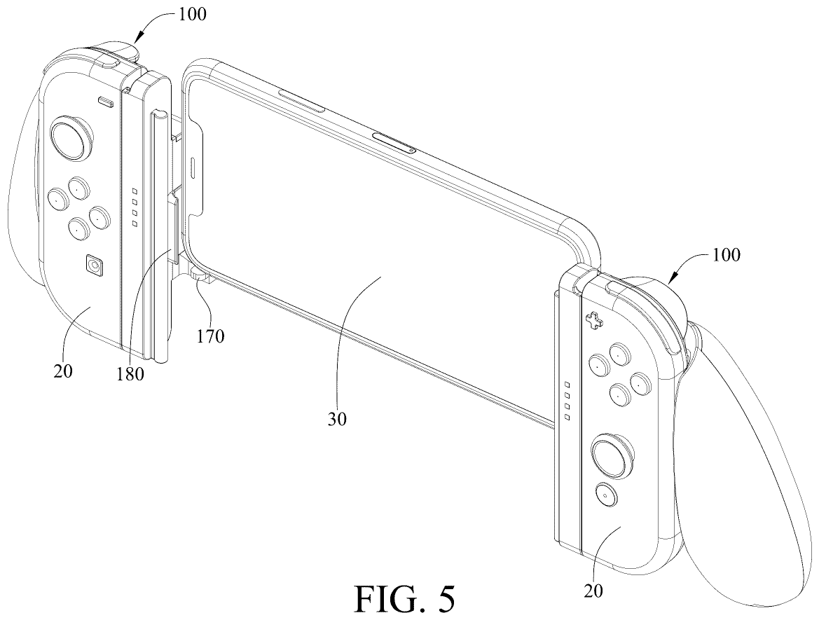

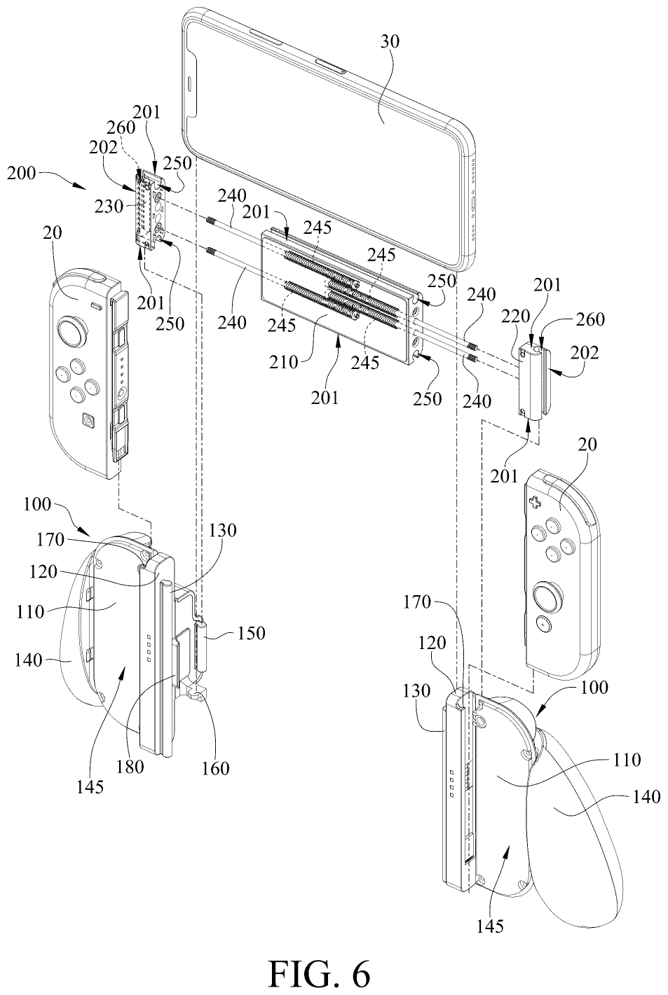

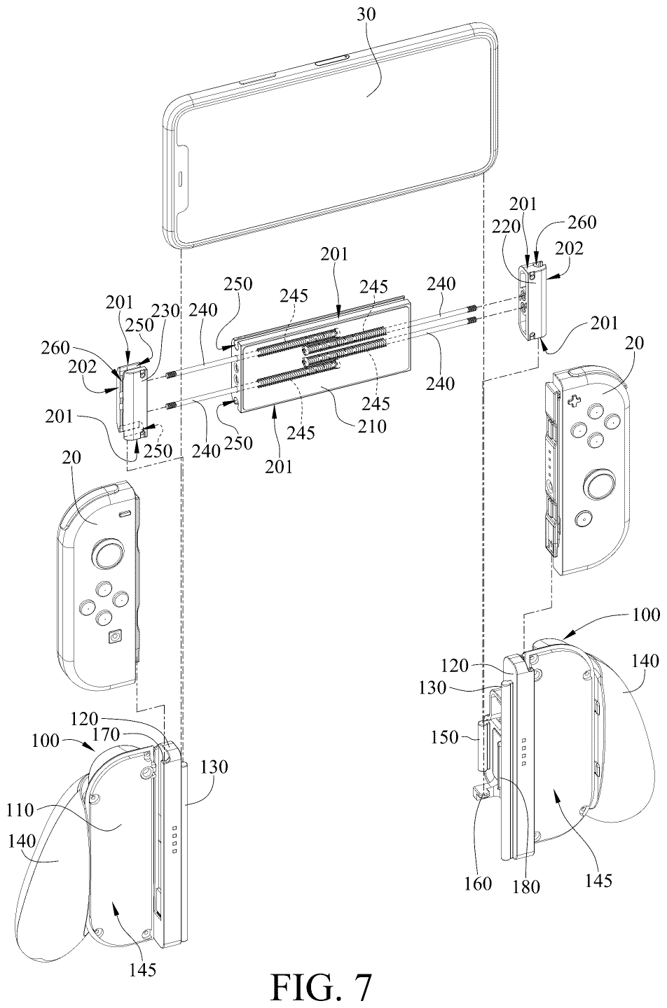

Please refer to FIGS. 4-7. FIG. 4 is a perspective view of the phone bracket 10 in FIG. 1 that is in an expanded state. FIG. 5 is a perspective view showing that the two controllers 20 and a smartphone 30 are supported on the phone bracket 10 in FIG. 1 that is in the expanded state. FIG. 6 is an exploded view of the controllers 20, the smartphone 30 and the phone bracket 10 in FIG. 5. FIG. 7 is an exploded view of the controllers 20, the smartphone 30 and the phone bracket 10 in FIG. 5 along another viewing angle.

Next, the expanded state of the phone bracket 10 will be described. As shown in FIGS. 4-7, when the phone bracket 10 is in the expanded state, the two second assembling structures 150 of the two controller supporting bodies 100 are slidably assembled to the two fourth assembling structures 260, respectively. Also, the phone bracket 10 is configured to support the smartphone 30. In detail, the two supporting protrusions 160 are configured to support the smartphone 30. Also, after the distance between the mounting bases 220 and 230 is adjusted, the two controller supporting bodies 100 clamp the smartphone 30 therebetween. In this embodiment, the controllers 20 are in wireless communication with the smartphone 30. Since the distance between the two mounting bases 220 and 230 is adjustable, different sizes of the smartphones 30 are allowed to be supported by the phone bracket 10. In addition, the blocking protrusion 180 is located on a side of the smartphone 30 to prevent the smartphone 30 from being detached from the phone bracket 10. In other embodiments, the controller supporting body may not include the blocking protrusion.

According to the descriptions regarding the stored state and the expanded state of the phone bracket 10, in this disclosure, the two controller supporting bodies 100 are selectively and respectively disposed on the two first side surfaces 201 or the two second side surfaces 202 of the mounting body 200 so as to adjust the distance between the two controller supporting bodies 100 and to allow the phone bracket 10 to selectively support the smartphone 30.

The disclosure is not limited by the configurations of the first assembling structures 130, the second assembling structures 150, the third assembling structures 250 and the fourth assembling structures 260. In other embodiments, the first assembling structures and the second assembling structures may be sliding grooves, and the third assembling structures and the fourth assembling structures may be sliders. Further, in this embodiment, for the convenience of assembly, the first assembling structures 130 and the second assembling structures 150 are designed to be sliders, and the third assembling structures 250 and the fourth assembling structures 260 are designed to be sliding grooves. However, the disclosure is not limited thereto. In other embodiments, the first assembling structures and the second assembling structure may be engagement protrusions, and the third assembling structures and the fourth assembling structures may be engagement recesses forming a snap fit with the said engagement protrusions.

In other embodiments without the demand of supporting smartphones of different sizes, the mounting body may not include the mounting bases, the mounting rods and the elastic components.

According to the phone bracket disclosed by above embodiments, the distance between the two first side surfaces is shorter than the distance between the two second side surfaces, and the two controller supporting bodies are respectively and selectively disposed on the two first side surfaces or the two second side surfaces of the mounting body so as to adjust the distance between the two controller supporting bodies. Thus, when the two controller supporting bodies are disposed on the two first side surfaces of the mounting body, the phone bracket has a smaller horizontal size, making it easier to be stored. Also, when the two controller supporting bodies are disposed on the two second side surfaces of the mounting body, the phone bracket has a larger horizontal size to support the smartphone.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A phone bracket, configured to support two controllers and a smartphone, the phone bracket comprising:
two controller supporting bodies, configured to support the two controllers, respectively; and
a mounting body, having two first side surfaces and two second side surfaces, wherein the two first side surfaces face away from each other, the two second side surfaces face away from each other, the two second side surfaces are located between the two first side surfaces, and a distance between the two first side surfaces is shorter than a distance between the two second side surfaces;
wherein the two controller supporting bodies are respectively and selectively disposed on the two first side surfaces or the two second side surfaces of the mounting body so as to adjust a distance between the two controller supporting bodies and to allow the phone bracket to selectively support the smartphone.

2. The phone bracket according to claim 1, wherein the mounting body comprises a base and two mounting bases, the two mounting bases are respectively and movably disposed on two opposite sides of the base so that a distance between the two mounting bases is adjustable, the base and the two mounting bases together form the two first side surfaces, and the two second side surfaces face away from the base and are located on the two mounting bases, respectively.

3. The phone bracket according to claim 2, wherein each of the two controller supporting bodies has a first assembling structure and a second assembling structure, the mounting body further comprises two third assembling structures and two fourth assembling structures, the two third assembling structures are located on the two first side surfaces, respectively, the two fourth assembling structures are located on the two second side surfaces, respectively, the phone bracket has a stored state and an expanded state; when the phone bracket is in the stored state, the two first assembling structures of the two controller supporting bodies are assembled to the two third assembling structures, respectively; and when the phone bracket is in the expanded state, the two second assembling structures of the two controller supporting bodies are assembled to the two fourth assembling structures, respectively, and the phone bracket is configured to support the smartphone.

4. The phone bracket according to claim 3, wherein the two first assembling structures and the two second assembling structures are sliders, the two third assembling structures and the two fourth assembling structures are sliding grooves; when the phone bracket is in the stored state, the two first assembling structures of the two controller supporting bodies are slidably assembled to the two third assembling structures, respectively; and when the phone bracket is in the expanded state, the two second assembling structures of the two controller supporting bodies are slidably assembled to the two fourth assembling structures, respectively.

5. The phone bracket according to claim 4, wherein the two third assembling structures are located on the base and one of the two mounting bases, and is spaced apart from another one of the two mounting bases.

6. The phone bracket according to claim 3, wherein each of the two controller supporting bodies comprises a supporting part, a mounting part and a handheld part, in each of the two controller supporting bodies, the mounting part and the handheld part are located on two opposite sides of the supporting part, respectively, the supporting part, the mounting part and the handheld part together form an accommodation space configured to accommodate one of the two controllers, the first assembling structure and the second assembling structure are located on a side of the mounting part that is located farthest away from the supporting part, and the first assembling structure is located closer to the accommodation space than the second assembling structure.

7. The phone bracket according to claim 6, wherein each of the two controller supporting bodies further comprises a supporting protrusion, in each of the two controller supporting bodies, the supporting protrusion protrudes from a side of the mounting part that is located farthest away from the supporting part, and is located between the first assembling structure and the second assembling structure; and when the phone bracket is in the expanded state, the two supporting protrusions are configured to support the smartphone.

8. The phone bracket according to claim 6, wherein each of the two controller supporting bodies further comprises an engagement protrusion, in each of the two controller supporting bodies, and the engagement protrusion protrudes toward the accommodation space from the mounting part, and is configured to be engaged with the controller.

9. The phone bracket according to claim 6, wherein each of the two controller supporting bodies further comprises a blocking protrusion, in each of the two controller supporting bodies, the blocking protrusion protrudes from a side of the mounting part that is located farthest away from the supporting part, and is located between the first assembling structure and the second assembling structure; and when the phone bracket is in the expanded state, the blocking protrusion is configured to be located on a side of the smartphone.

10. The phone bracket according to claim 2, wherein the mounting body further comprises a plurality of mounting rods and a plurality of elastic components, the plurality of mounting rods are disposed through the base, and the two mounting bases are movably disposed on the base via the plurality of mounting rods and the plurality of elastic components.
